(19) United States
(12) Patent Application Publication
(10) Pub. No.: US 2005/0183033 A1
(43) Pub. Date: Aug. 18, 2005

(54) Apparatus and methods for displaying dialog box text messages including languages having different reading orders

(76) Inventors: Yaniv Feinberg, Redmond, WA (US); Soohad Khoury, Bellevue, WA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/782,171

(22) Filed: Feb. 18, 2004

(51) Int. Cl. G06F 17/28

(52) U.S. Cl. 715/809

(57) ABSTRACT

An apparatus and methods for displaying a text message including languages or scripts having different alignment and different reading orders in a readable manner in a dialog box of a computer system user interface. The apparatus and methods include, in an exemplary embodiment, a computer software routine for determining an appropriate reading order for each sentence of the mixed language text message by detecting and evaluating at least one alphabetic character of each sentence's plurality of characters to ascertain the language to which the at least one character belongs and the reading order of such language. The apparatus and methods further determine an appropriate alignment for the mixed language text message based at least in part on the alignment otherwise employed by the computer system user interface to display text.

### FIELD OF THE INVENTION

The present invention relates, generally, to the field of apparatuses and methods for displaying text messages in a computer system user interface and, more specifically, to apparatuses and methods for displaying dialog box text messages including languages having different reading orders in a computer system user interface.

### BACKGROUND OF THE INVENTION

Today, computer systems are used around the world and, as a consequence, computer systems must be capable of displaying textual messages to computer system users in many different languages or scripts. Traditionally, the display of textual messages to users has been enabled by requiring a computer system's user to select a language or script in which text, including the textual messages presented to the user via dialog boxes of a computer system user interface, is to be displayed to the user by the computer system. Unfortunately, the selection of a language, or script generally, establishes the reading order and text alignment to be employed by a computer system when displaying all textual messages. As a consequence, if the computer system is to display a textual message including text from multiple languages or scripts that have different reading orders, only the text in a language or script having a reading order identical to that of the language or script selected by the user will be displayed in a readable manner.

For example, in the English language, text is left-aligned and is read in a left-to-right reading order. In the Hebrew language, text is right-aligned and is read in a right-to-left reading order. When a computer system must display a text message including text from languages or scripts having different alignments and different reading orders such as English and Hebrew in a dialog box of a computer system user interface and the computer system is set to one of languages or scripts, the text including the language or script to which the computer system is set will be displayed in a readable manner with correct alignment and reading order, but the text from the other language or script will be displayed in an unreadable manner with incorrect alignment and reading order.

Therefore, there exists in the industry, a need for an apparatus and methods for displaying text messages in dialog boxes of a computer system user interface including text from languages or scripts having different alignment and different reading orders in a readable manner, and that addresses these and other shortcomings or difficulties which exist now or in the future.

### SUMMARY OF THE INVENTION

Broadly described, the present invention comprises an apparatus and methods for displaying a text message including languages or scripts having different alignment and different reading orders in a readable manner. More particularly, the present invention comprises an apparatus and methods for displaying a mixed language text message in a dialog box of a computer system user interface in a readable manner. The apparatus includes computer software, which when executed by a computer system, cause the computer system to perform methods which include, in an exemplary embodiment, determining an appropriate reading order for each sentence of a mixed language text message by detecting and evaluating at least one character of each sentence of the message to ascertain (i) the language or script to which the at least one character belongs and (ii) the reading order of such language or script. In performing such an evaluation, each successive character of a sentence's plurality of characters is considered to locate a first alphabetic character and, upon locating a first alphabetic character, the language or script to which such first alphabetic character belongs is ascertained and, hence, the reading order of that alphabetic character is also ascertained. The reading order of the alphabetic character is then employed to display the sentence of the mixed language text message in the dialog box of the computer system user interface. Such evaluation and determination of the reading order is repeated for each sentence of a mixed language text message prior to the display of each sentence in the dialog box of the computer system user interface.

The apparatus and methods of the present invention further include, in the exemplary embodiment, computer software which causes the computer system to perform methods that determine an appropriate alignment for the mixed language text message when the computer software is executed by the computer system. Such a determination includes ascertaining the alignment of the language or script otherwise employed by the computer system user interface to display text. The determined reading order and alignment are then used to display the mixed language text message in the dialog box of the computer system user interface.

Advantageously, the apparatus and methods of the present invention enable a computer system to display a text message comprising text having more than one language or script in a readable manner. For example, the apparatuses and methods enable a text message having text from a language such as the English language which is written and/or read in the left-to-right direction and text from a language such as the Hebrew language which is written and/or read in the right-to-left direction to be displayed in a dialog box in a readable manner by determining an appropriate alignment for the text message and an appropriate reading order for each sentence thereof. If such alignment and reading order(s) were not determined and utilized, the text message may include at least a portion that is unreadable.

Other advantages and benefits of the present invention will become apparent upon reading and understanding the present specification when taken in conjunction with the appended drawings.

### BRIEF DESCRIPTION OF THE DRAWINGS

FIG. 1 displays a block diagram representation of a dialog box display routine of the present invention for displaying text messages including languages or scripts having different alignment and reading orders and an environment in which the dialog box display routine operates in accordance with an exemplary embodiment.

FIG. 2 displays a block diagram representation of components of a computer system and environment therefor, according to the exemplary embodiment, which may be utilized to implement the dialog box display routine and methods of the present invention.

FIG. 3 displays a flowchart representation of a method of the present invention for displaying a text message in a dialog box including languages or scripts having different alignment and reading orders that is implemented by the dialog box display routine in accordance with the exemplary embodiment.

FIGS. 4A and 4B display a flowchart representation of a method of the present invention for determining and establishing a reading order for an individual sentence of a text message that is implemented by the dialog box display routine in accordance with the exemplary embodiment.

### DETAILED DESCRIPTION OF THE INVENTION

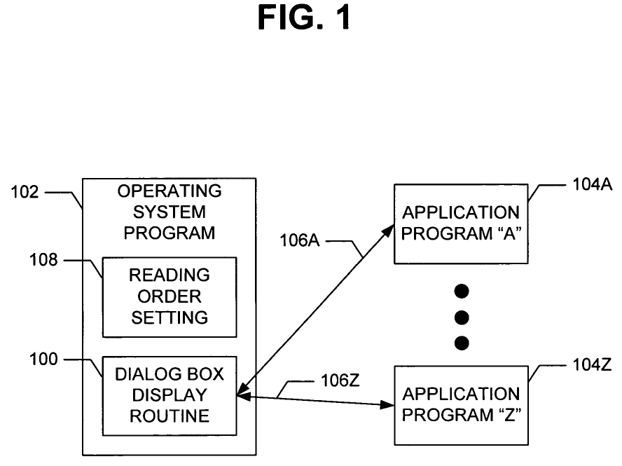

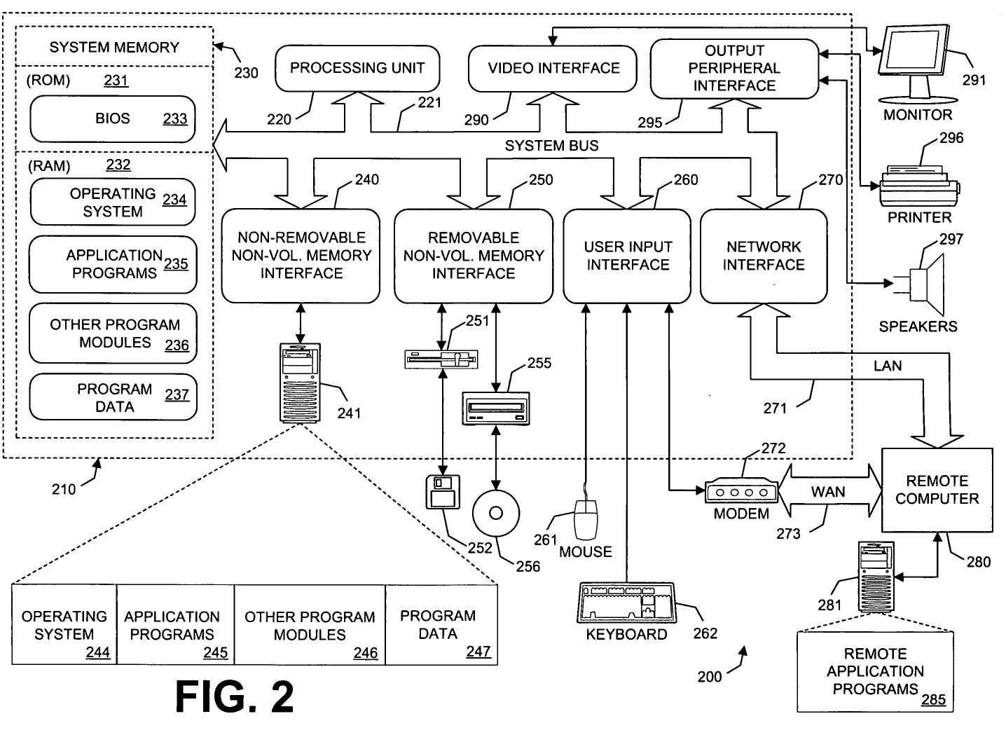

Referring now the drawings in which like numerals represent like elements or steps throughout the several views, FIG. 1 displays a block diagram representation of a dialog box display routine 100 of the present invention for displaying text messages including languages or scripts having different alignment and reading orders (also sometimes referred to herein as “mixed language text messages” or “bidirectional text messages”) in a dialog box of a computer system graphical user interface and an environment in which the dialog box display routine 100 operates in accordance with an exemplary embodiment. The dialog box display routine 100 resides on a computer system 210 similar to that described below with reference to FIG. 2 and, generally, comprises programming, program modules, and/or machine instructions that, when executed by a processing unit 220 of the computer system 210, implement and perform methods 300, 400 (described below) of the present invention for determining and setting the alignment and reading order to be used by the computer system 210 when displaying each sentence of mixed language text messages, for causing the readable display of such messages in dialog boxes, and for providing the other capabilities and functionality described herein.

The dialog box display routine 100 may be, as illustrated in FIG. 1, incorporated into an operating system program 102 which is also resident on the computer system 210 such that operation of dialog box display routine 100 may be initiated by the operating system program 102 in order to display text messages, including mixed language text messages, to a user of the computer system 210. Generally, the operating system program 102, as is known to those skilled in the art, controls the operations of the computer system 210 and provides basic functionality, such as the display of dialog boxes in a graphical user interface thereof which is displayed on a monitor 291 or other display device, to application programs 104 that may also reside on the computer system 210 and that may also initiate operation of the dialog box display routine 100 by making appropriate system calls to the operating system program 102 and to the dialog box display routine 100 as indicated by arrows 106 in FIG. 1. An operating system program 102 which may incorporate and utilize the dialog box display routine 100 of the present invention includes, but is not limited to, the Microsoft® Windows XP operating system program and other similar operating system programs available from Microsoft Corporation of Redmond, Wash. Application programs 104 that are acceptable in accordance with the exemplary embodiment hereof include, but are not limited to, computer software programs such as Microsoft® Word, Microsoft® Excel, Microsoft® Access, and other similar application programs available from Microsoft Corporation of Redmond, Wash. It should be noted, however, that the dialog box display routine 100 of the present invention may also, in other embodiments thereof, be associated with or incorporated into the application programs themselves or, perhaps, be utilized as a standalone routine.

The operating system program 102 includes a reading order setting 108 or other similar setting which is, generally, stored during operation of the computer system 210 in system memory 230 such that the then current reading order setting 108 is accessible to the operating system program 102 and/or the application programs 104. The reading order setting 108 comprises a setting utilized by the operating system program 102 to determine the alignment and order of words that it is to use when causing the computer system 210 to display text to a user via a monitor 291 or other display device. Generally, the reading order setting 108 is selected by a user of the computer system 210 when the user selects and identifies to the computer system 210 during set-up thereof, a primary language, or script, that the computer system 210 is to employ when displaying text to the user. For example and not limitation, when a user selects and identifies the English language as a primary language for the computer system 210 to use, the selection of the English language and the setting established thereby informs the computer system 210 that it is to display text using a left alignment with the reading order of the words being left-to-right (i.e., since, in the English language, the first words of sentences and paragraphs are aligned at the left side of a document and the remaining words of sentences are written and/or read in a direction from left-to-right). Alternately, when a user selects and identifies the Hebrew language as a primary language for the computer system 210 to use, the selection of the Hebrew language and the setting established thereby informs the computer system 210 that it is to display text using a right alignment with the reading order of the words being right-to-left (i.e., since, in the Hebrew language, the first words of sentences and paragraphs are aligned at the right side of a document and the remaining words of sentences are written and/or read in a direction from right-to-left).

In most past and present versions of the Microsoft® Windows operating system program, for instance, the reading order setting corresponds to a code page number that is selected and identified during the set-up of a computer system 210 utilizing the Microsoft® Windows operating system program. The code page number, generally, is associated with and identifies a language and a code page comprising a character set including a plurality of alphanumeric, punctuation, and special characters of a language or script. In so identifying the language, the code page number also establishes the alignment and reading order to be used by the computer system 210 when displaying text. It should be understood, however, that with respect to the scope of the present invention, the term “reading order setting” includes one or more settings or stored values that may, alone or in combination, define the alignment and reading order that a computer system is to employ when displaying text.

FIG. 2 displays a block diagram representation of a computing environment 200 and computer systems 210, 280 thereof on which the present invention may be implemented in accordance with the exemplary embodiment thereof. The computing environment 200 and computer systems 210, 280 thereof represent only one example of a suitable computing environment and computer systems for the practice of the present invention and are not intended to suggest any limitation as to the scope of use or functionality of the invention. Nor should the computer systems 210, 280 be interpreted as having any dependency or requirement relating to any one or combination of components illustrated in the exemplary computing environment 200.

Hence, it should be understood that the present invention is operational with numerous other general purpose or special purpose computing system environments or configurations. Examples of well-known computing systems, environments, and/or configurations that may be appropriate or suitable for use as a computer system of the present invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The present invention may also be described in the general context of comprising computer-executable instructions, such as program modules, being executed by a computer system. Generally, program modules include routines, programs, programming, objects, components, data, data structures, etc. that perform particular tasks or implement particular abstract data types. The present invention may be practiced in distributed computing environments where tasks are performed by remote processing devices that are linked through a communications network. In a distributed computing environment, program modules may be located in both local and remote computer storage media, including, without limitation, in memory storage devices.

With reference to FIG. 2, an exemplary computer system of the present invention includes a general purpose computing device in the form of a computer system 210. Components of computer system 210 may include, but are not limited to, a processing unit 220, a system memory 230, and a system bus 221 that couples various system components including the system memory 230 to the processing unit 220 for bidirectional data and/or instruction communication. The system bus 221 may be any of several types of bus structures including a memory bus or memory controller, a peripheral bus, and a local bus using any of a variety of bus architectures. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (i.e., also known as the “Mezzanine bus”).

Computer system 210 typically includes a variety of computer-readable media. Computer-readable media may comprise any available media that can be accessed by, read from, or written to by computer system 210 and may include both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data, data structures, program modules, programs, programming, or routines. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, magneto- optical storage devices, or any other medium which can be used to store the desired information and which can be accessed by computer system 210. Communication media typically embodies computer-readable instructions, data, data structures, program modules, programs, programming, or routines in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer-readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically stores data and/or program instructions that are immediately accessible to and/or presently being operated on by processing unit 220. By way of example, and not limitation, FIG. 2 illustrates operating system 234, application programs 235, other program modules 236, and program data 237 which may be resident in RAM 232, in whole or in part, from time-to-time.

The computer 210 may also include other removable/non-removable, volatile/nonvolatile computer storage media. By way of example only, FIG. 2 illustrates a hard disk drive 241 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that may be included in the exemplary computing environment 200 include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives 241, 251, 255 and their associated computer storage media discussed above and illustrated in FIG. 2, provide storage of computer-readable instructions, data, data structures, program modules, programs, programming, or routines for computer system 210. In FIG. 2, for example, hard disk drive 241 is illustrated as storing operating system 244, application programs 245, other program modules 246, and program data 247. Note that these components may either be the same as or different from operating system 234, application programs 235, other program modules 236, and program data 237. Operating system 244, application programs 245, other program modules 246, and program data 247 are given different numbers to illustrate that, at a minimum, they are different copies of operating system 234, application programs 235, other program modules 236, and program data 237. A user may enter commands and information into computer system 210 through connected input devices such as a keyboard 262 and pointing device 261, commonly referred to as a mouse, trackball or touch pad. Other connected input devices (not shown) may include a microphone, joystick, game pad, satellite dish, scanner, or the like. These and other input devices are often connected to the processing unit 220 through a user input interface 260 that is coupled to the system bus 221, but may be connected by other interface and bus structures, such as a parallel port, game port or a universal serial bus (USB). A monitor 291 or other type of display device is also connected to the system bus 221 via an interface, such as a video interface 290. In addition to the monitor 291, computer system 210 may also include other peripheral output devices such as speakers 297 and printer 296, which may be connected through an output peripheral interface 295.

The computer system 210 may operate in a networked environment using logical bi-directional communication connection links to one or more remote computer systems, such as a remote computer system 280. The remote computer system 280 may be a personal computer, a server, a router, a network PC, a peer device or other common network node, and typically includes many or all of the elements described above relative to the computer system 210, although only a memory storage device 281 of remote computer system 280 has been illustrated in FIG. 2. The logical bi-directional communication connection links depicted in FIG. 2 include a local area network (LAN) 271 and a wide area network (WAN) 273, but may also include other networks. Such networks are commonplace in offices, enterprise-wide computer networks, intranets and the Internet.

When communicatively connected to a LAN 271, the computer system 210 connects to the LAN 271 through a network interface or adapter 270. When communicatively connected to a WAN 273, the computer system 210 typically includes a modem 272 or other means for establishing a communication link over the WAN 273, such as the Internet. The modem 272, which may be internal or external, may be connected to the system bus 221 via the user input interface 260, or other appropriate mechanism. In a networked environment, program modules depicted relative to the computer system 210, or portions thereof, may be stored in the remote memory storage device 281. By way of example, and not limitation, FIG. 2 illustrates remote application programs 285 as residing in memory storage device 281. It will be appreciated that the network connections shown are exemplary and other means of establishing a bi-directional communication link between the computers may be used.

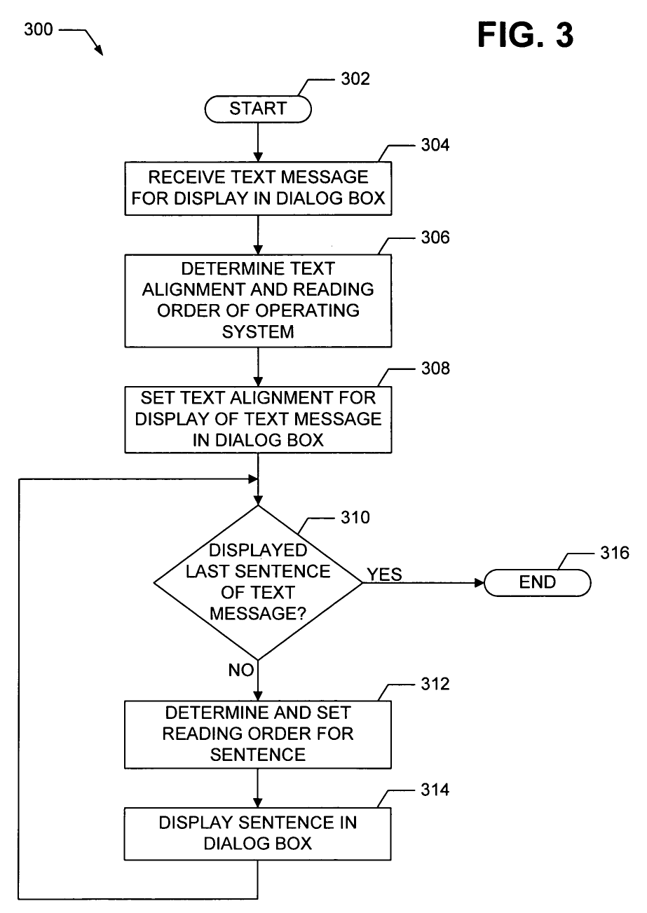

FIG. 3 displays a flowchart representation of a method 300 of the present invention for displaying, in a dialog box, a text message including languages or scripts having different alignment and reading orders that is used or implemented by the dialog box display routine 100 in accordance with the exemplary embodiment. After starting at step 302, the method 300 advances to step 304 where the dialog box display routine 100 receives a mixed language text message for display in a dialog box of a computer system user interface on a monitor 291 or other display device of computer system 210. The mixed language text message may be received from the operating system program 102 or from an application program 104, for example, as a passed or common area parameter. Once the mixed language text message has been received, the text alignment and reading order of the operating system program 102 are determined at step 306. Generally, such a determination is made by examining the reading order setting 108 or other similar setting or settings, alone or in combination, to ascertain whether the operating system program 102 has been set-up to display text with a left alignment and a left-to-right reading order or with a right alignment and a right-to-left reading order. For example, if the examined setting corresponds to a setting indicating the primary language or script that the operating system program 102 uses when displaying text, then such determination becomes one of determining the language or script and, once the language or script is known, the alignment and reading order of such language is also known.

Next, at step 308, the text alignment for the display of the mixed language text message is set to be the same as the text alignment of the operating system program 102. Then, at step 310, method 300 enters a loop of steps (i.e., including steps 310, 312, and 314) that are performed for each sentence present in the mixed language text message. At step 310, a determination is made as to whether the last sentence of the mixed language text message has already been displayed in the dialog box. If not, the reading order for display of the next sentence of the mixed language text message is determined and set, or established, for the next sentence in accordance with method 400 (described below) at step 312. It should be noted that the term “next sentence” refers to the first sentence of the mixed language text message on the first pass through the loop or to a sequentially subsequent sentence of the mixed language text message on a respective subsequent pass through the loop. If, at step 310, it is determined that the last sentence of the mixed language text message has already been displayed in the dialog box on the monitor 291 or other display device, the method 300 ends at step 316 with each sentence of the mixed language text message having been displayed in the dialog box in a readable manner.

Once the reading order of the next sentence of the mixed language text message has been established at step 312, the next sentence of the mixed language text message is displayed in the dialog box on the monitor 291 or other display device at step 314 using the text alignment and reading order of the next sentence as established and described above, and overriding the reading order setting 108 or other similar setting or settings of the operating system program 102. After display of the next sentence at step 314, method 300 loops back to step 310 where, once again, a determination is made as to whether the last sentence of the mixed language text message has already been displayed in the dialog box.

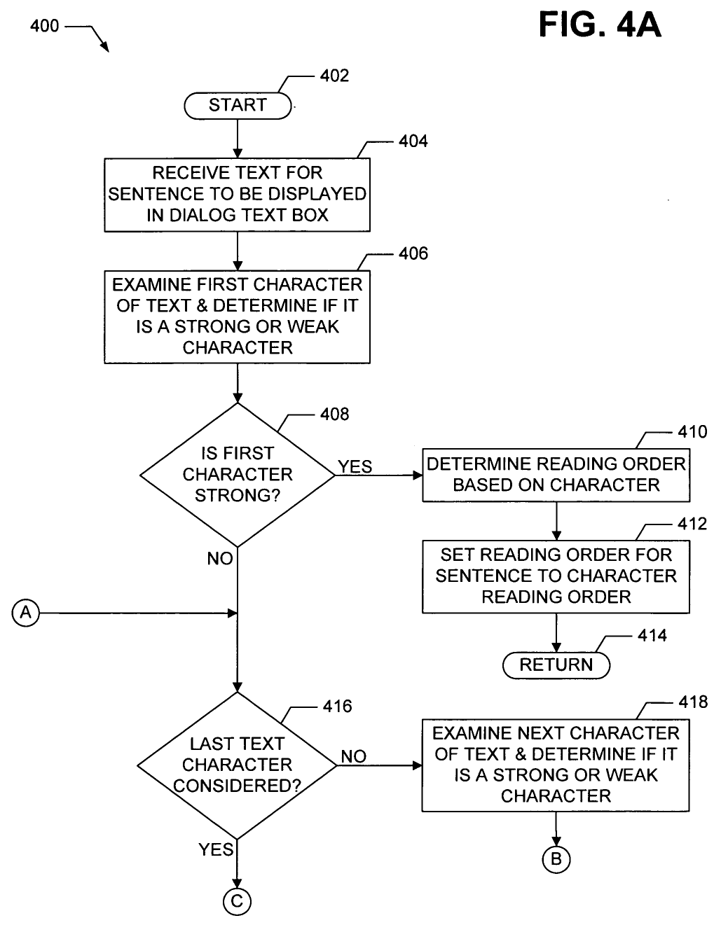

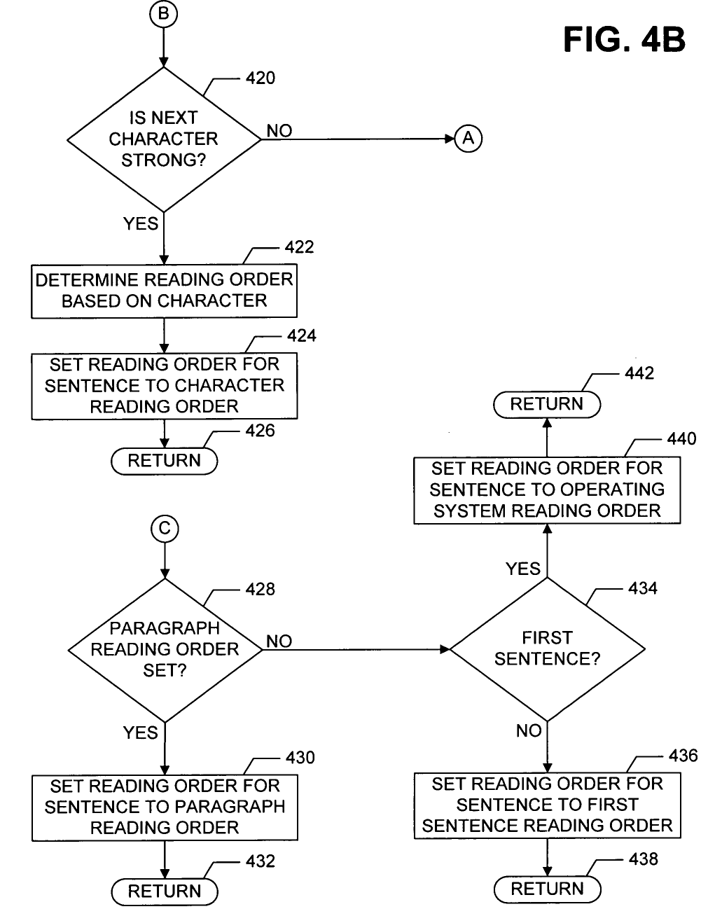

FIG. 4 displays a flowchart representation of a method 400 of the present invention for determining and setting, or establishing, a reading order for an individual sentence of a mixed language text message that is used or implemented by the dialog box display routine 100 and method 300 (described above) in accordance with the exemplary embodiment. After starting at step 402, the method 400 advances to step 404 where the dialog box display routine 100 receives the text of a sentence including one or more characters to be displayed in a dialog box of a computer system user interface on a monitor 291 or other display device of computer system 210. Then, at step 406, the first character of the sentence text is examined and a determination is made as to whether the first character comprises a “strong character” or a “weak character”. As used herein, the term “strong character” comprises an alphabetic character of a language or script, and the term “weak character” comprises a numeric character, punctuation character, special character, or a non-alphabetic character of a language or script.

Continuing at step 408 of method 400, if the first character of the sentence text was determined to be a strong character of a particular language or script at step 406, the method 400 branches to step 410 where the reading order for the sentence is determined based upon the first character and the language or script to which the first character belongs. Next, at step 412, the reading order for the sentence is set, or established, to be the reading order for the first character. At step 414, method 400 ends and returns to method 300 with the reading order for the sentence having been set or established.

If, at step 408, it is ascertained that the first character of the sentence text is not a strong character (i.e., the first character is, instead, a weak character), the method 400 proceeds to step 416 where a loop of steps (i.e., including steps 418, 420, 422, and 424) is entered into that are performed for each of the remaining one or more characters of the sentence text until a strong character is detected or until all remaining characters are examined for the existence of a strong character. At step 416, a test is made to determine whether the last character of the sentence text has already been considered while attempting to locate a strong character in the sentence text. If the last character has not already been considered, the “next character” of the sentence text is examined and a determination is made, at step 418, as to whether the next character comprises a strong character or a weak character. As used herein, the term “next character” refers to a sequentially subsequent character of the sentence text that is individually examined on a respective subsequent pass through the loop.

Next, at step 420, a decision is made as to whether the next character of the sentence text was determined to be a strong character of a particular language or script at step 418. If so, the method 400 branches to step 422 where the reading order for the sentence is determined based upon the next character and the language or script to which the next character belongs. Then, at step 424, the reading order for the sentence is set, or established, to be the reading order for the next character (i.e., the reading order of the language or script to which the next character belongs). At step 426, method 400 ends and returns to method 300 with the reading order for the sentence having been set or established. If, at step 420, it is decided that the next character of the sentence text is not a strong character (i.e., but is, instead, a weak character), the method 400 branches back to step 416 where a determination is once again made as to whether the last character of the sentence text has been considered.

If a decision is made, at step 416, that the last character of the sentence text has been examined for the presence of a strong character, then no strong character exists in the sentence text and the method 400 proceeds to step 428 where a determination is made as to whether a reading order has been established for the paragraph in which the sentence is present. If a reading order has already been established for the paragraph, then the reading order for the sentence is set to the already existing reading order of the paragraph at step 430. Then, the method 400 ends at step 432 and returns to method 300 with the reading order for the sentence having been set or established.

If, at step 428, it is determined that a reading order has not already been established for the paragraph in which the sentence is present, the method 400 advances to step 434 where it is ascertained whether the sentence is the first sentence of the text message. If not, the reading order for the sentence is set, or established, to be the reading order for the first sentence of the text message at step 436. Then, the method 400 ends and returns to method 300 at step 438 with the reading order for the sentence having been set or established. If it is ascertained, at step 434, that the sentence is the first sentence of the text message, the reading order for the sentence is set, or established, at step 440 to be the same as the reading order of the operating system program 102 by examining the reading order setting 108 or other similar setting or settings of the operating system program 102, alone or in combination, to ascertain whether the operating system program 102 has been set-up to display text with a left-to-right reading order or with a right-to-left reading order. Subsequently, the method 400 ends and returns to method 300 at step 442 with the reading order for the sentence having been set or established.

Whereas the present invention has been described in detail above with respect to an exemplary embodiment thereof, it is understood that variations and modifications can be effected within the spirit and scope of the invention, as described herein before and as defined in the appended claims.

1. A method of displaying a mixed language text message in a dialog box, the method comprising the steps of:
determining a reading order for a sentence of a mixed language text message to be displayed in a dialog box of a computer system user interface of a computer system operating system, the reading order being appropriate to render the sentence readable upon display thereof;
determining an alignment for the mixed language text message, the alignment being appropriate to render the mixed language text message readable upon display thereof; and,
displaying the mixed language text message in the dialog box of the computer system user interface using the determined reading order and alignment.

2. The method of claim 1, wherein the mixed language text message comprises a plurality of characters, and the step of determining a reading order comprises a step of evaluating at least one character of the plurality of characters to ascertain the language to which the at least one character belongs and the reading order of such language.

3. The method of claim 2, wherein the step of evaluating comprises the steps of considering each successive character of the plurality of characters to locate a first alphabetic character, and upon locating a first alphabetic character, ascertaining the language to which the first alphabetic character belongs and the reading order of such language.

4. The method of claim 3, wherein the method further comprises a step of, upon not locating a first alphabetic character, determining the reading order of the language otherwise employed by the computer system user interface to display text.

5. The method of claim 1, wherein the step of determining an alignment comprises a step of determining the alignment of the language otherwise employed by the computer system user interface to display text.

6. The method of claim 1, wherein the step of displaying comprises a step of overriding the reading order setting otherwise employed by the computer system user interface to display text.

7. A computer-readable medium having computer-executable instructions for displaying a mixed language text message in a dialog box, the computer-executable instructions performing steps comprising:
determining a reading order for a sentence of a mixed language text message to be displayed in a dialog box of a computer system user interface of a computer system operating system, the reading order being appropriate to render the sentence readable upon display thereof;
determining an alignment for the mixed language text message, the alignment being appropriate to render the mixed language readable upon display thereof; and,
displaying the mixed language text message in the dialog box of the computer system user interface using the determined reading order and alignment.

8. The computer readable medium of claim 7, wherein the mixed language text message comprises a plurality of characters, and the step of determining a reading order comprises a step of evaluating at least one character of the plurality of characters to ascertain the language to which the at least one character belongs and the reading order of such language.

9. The computer readable medium of claim 8, wherein the step of evaluating comprises the steps of considering each successive character of the plurality of characters to locate a first alphabetic character, and wherein the computer readable medium further comprises computer-executable instructions for, upon locating a first alphabetic character, ascertaining the language to which the first alphabetic character belongs and the reading order of such language.

10. The computer readable medium of claim 9, wherein the computer readable medium further comprises computer-executable instructions for, upon not locating a first alphabetic character, determining the reading order of the language otherwise employed by the computer system user interface to display text.

11. The computer readable medium of claim 7, wherein the step of determining an alignment comprises a step of determining the alignment of the language otherwise employed by the computer system user interface to display text.

12. The computer readable medium of claim 7, wherein the step of displaying comprises a step of overriding the reading order setting otherwise employed by the computer system user interface to display text.

13. A method of establishing a reading order for a sentence of a mixed language text message to be displayed in a dialog box of a computer system user interface, the method comprising the steps of:
examining characters of a sentence of a mixed language text message in succession in an attempt to locate an alphabetic character;
in response to locating an alphabetic character in the sentence, determining the reading order of the located alphabetic character by ascertaining the language or script to which the located alphabetic character belongs; and,
in response to locating an alphabetic character in the sentence, setting the reading order of the sentence of the mixed language text message to be the reading order of the located alphabetic character.

14. The method of claim 13, wherein the method further comprises, in response to not locating an alphabetic character in the sentence, the steps of:
determining whether a reading order has previously been established for a paragraph in which the sentence is present; and,
in response to determining that a reading order has previously been established for the paragraph, setting the reading order of the sentence of the mixed language text message to be the reading order of the paragraph.

15. The method of claim 13, wherein the method further comprises, in response to not locating an alphabetic character in the sentence, the steps of:
determining whether the sentence comprises a first sentence of the mixed language text message; and,
in response to determining that the sentence comprises a first sentence of the mixed language text message, setting the reading order of the sentence of the mixed language text message to be the reading order used by an operating system program to display text in the computer system user interface.

16. The method of claim 13, wherein the method further comprises, in response to not locating an alphabetic character in the sentence, the steps of:
determining whether the sentence comprises a first sentence of the mixed language text message; and,
in response to determining that the sentence does not comprise a first sentence of the mixed language text message, setting the reading order of the sentence of the mixed language text message to be the reading order of the first sentence of the mixed language text message.
